(19) United States
(12) Patent Application Publication
(10) Pub. No.: US 2024/0242252 A1
(43) Pub. Date: Jul. 18, 2024

(54) SYSTEM, METHOD, AND COMPUTER PROGRAM FOR RATING BASED CHARGING

(71) Applicant: RAKUTEN SYMPHONY SINGAPORE PTE. LTD., Singapore (SG)

(72) Inventor: Mayur KACHHADIYA, Indore (IN)

(73) Assignee: RAKUTEN SYMPHONY SINGAPORE PTE. LTD., Singapore (SG)

(21) Appl. No.: 18/009,407

(22) PCT Filed: Sep. 22, 2022
(86) PCT No.: PCT/US2022/044316

§ 371 Date: Dec. 9, 2022

(51) Int. Cl. G06Q 30/0283; G06Q 30/0645

(52) U.S. Cl. CPC G06Q 30/0283; G06Q 30/0645

(57) ABSTRACT

A method for computing a service fee for a rental item, performed by at least one processor, is provided. The method includes receiving usage data corresponding to a customer from a sensor device and base fee information from one of a plurality of service platforms, mapping the usage data to user information from the plurality of service platforms, the user information including previous user ratings of the customer, generating a final score of the customer based on the mapped usage data, and computing a service fee to be charged based on the final score and the base fee information.

### 1. FIELD

Apparatuses and methods consistent with example embodiments of the present disclosure relate to computing service fees for a user using a rating based approach.

### 2. DESCRIPTION OF RELATED ART

In the related art, service fee computing is based only on a consumption of a customer. For example, for a car rental service, customer's usage may be computed based on travelled mileage and then bill the customer based on the usage. Further, a rental fee of an electric vehicle may be set based on a level deterioration of the vehicle's battery, wherein the deterioration of the battery is computed based on user's usage data collected during the rental period. As such, the rental fee is computed as per usage or per rental basis based on the data collected by the rental company during the renting period. The rental fee computation is standardized for all customers regardless of the customer's behavior (e.g., whether or not a customer is a loyal customer to the rental company, whether or not a customer has a negative driving history, etc.). Accordingly, a loyal customer does not get rewarded (e.g., by receiving a discount in the rental fee) and may decide to change to another rental company.

On the other hand, a customer may have bad habits that introduce additional costs which cannot be accounted for in the conventional system. For example, the customer may make the internal and/or external of a rented car dirty (which may require additional cleaning cost), the rented car may require additional restoration (which may also come at an additional cost), etc. Conventional systems do not provide an approach or method for solving this issue, particularly when a new customer is renting/utilizing a service item for the first time (i.e., the renting company does not have any record of the customer, etc.). Thus, the current rent pricing model may not be fair to the rental company.

Thus, there is a need to provide a solution to enhance the service fee computation that is not limited to customer usage and/or consumption, so as to reduce churn rate of loyal customers and to charge customers a service fee that more clearly reflects their behavior in addition to the actual consumption of the service (e.g., travelled mileage, battery consumption, etc.).

### SUMMARY

According to example embodiments, systems and methods are provided for computing a service fee of a rental item.

According to example embodiments, a method, performed by at least one processor includes: receiving usage data corresponding to a customer from a sensor device and base fee information from one of a plurality of service platforms; mapping the usage data to user information from the plurality of service platforms, the user information including previous user ratings of the customer; generating a final score of the customer based on the mapped usage data; and computing a service fee to be charged based on the final score and the base fee information.

The usage data may be received at an end of a rental period of the rental item. Further, the current rating may be the final score.

The method may further include generating a current rating based on the usage data and updating the plurality of service platforms with the current rating, wherein the current rating is stored as a previous user rating of the customer.

The method may further include generating the final score of the customer based on the current rating and the mapped usage data.

The method may further include charging the customer based on the generated service fee.

The method may further include generating the final score based on the mapped usage data and user information associated with other customers of one or more of the plurality of service platforms.

According to example embodiments, an apparatus for computing a service fee for a rental item, includes: at least one memory configured to store program code; and at least one processor configured to read the program code and operate as instructed by the program code. The program code configured to case the at least one processor to: receive usage data corresponding to a customer from a sensor device and base fee information from one of a plurality of service platforms; map the usage data to user information from the plurality of service platforms, the user information including previous user ratings of the customer; generate a final score of the customer based on the mapped usage data; and compute a service fee to be charged based on the final score and the base fee information.

The apparatus may further include wherein the at least one processor is configured to read the program code and operate as instructed by the program code to generate a current rating based on the usage data and updating the plurality of service platforms with the current rating, wherein the current rating is stored as a previous user rating of the customer.

The apparatus may further include wherein the at least one processor is configured to read the program code and operate as instructed by the program code to generate the final score of the customer based on the current rating and the mapped usage data.

The apparatus may further include wherein the at least one processor is configured to read the program code and operate as instructed by the program code to charge the customer based on the generated service fee.

The usage data may be received at an end of a rental period of the rental item. Further, the current rating may be the final score.

The apparatus may further include wherein the at least one processor is configured to read the program code and operate as instructed by the program code to generate the final score based on the mapped usage data and user information associated with other customers of one or more of the plurality of service platforms.

According to example embodiments, a non-transitory computer readable medium storing instructions that, when executed by at least one processor of an apparatus for computing a service fee for a rental item, cause the at least one processor to: receive usage data corresponding to a customer from a sensor device and base fee information from one of a plurality of service platforms; map the usage data to user information from the plurality of service platforms, the user information including previous user ratings of the customer; generate a final score of the customer based on the mapped usage data; and compute a service fee to be charged based on the final score and the base fee information.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1A is an example system overview according to one or more embodiments.

FIG. 1B is a flowchart of an example process utilized by a bill management system according to one or more example embodiments;

FIG. 2 is a diagram of an example environment in which systems and/or methods, according to one or more embodiments, may be implemented;

FIG. 3 is a diagram of example components of a device according to one or more embodiments;

FIG. 4 illustrates an example of a diagram of a bill management system according to one or more embodiments;

FIG. 5 is a sequence diagram illustrating an example of a data flow according to one or more embodiments;

FIG. 6 is an exemplary flowchart illustrating a method for computing a service fee according to one or more embodiment; and

FIG. 7 a block diagram of an example of computer code for computing a service fee according to one or more embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system for computing service fees (e.g., rental fee, etc.) for a user based on user information (e.g., a user's rating, a user's rental status, rental history, etc.), user behavior (e.g., actual behavior during a current rental period), and consumption (i.e., consumption of services, use of the rented item, etc.)

In one or more example embodiments, the method and system provide a solution wherein data on various instances of vehicle driving (e.g., speeding, harsh breaking, high speed turns, changing lanes/turning the vehicle without signaling the change/turn, leaving the vehicles high beams on, etc.) may be periodically sent to the vehicle rental company. The data may be recoded using a device, sensors (e.g., SIM-based IoT sensors), or the like installed with software or program configured to control the device to obtain the data and transmit the data to be analyzed. One or more artificial intelligence (AI) software/applications (e.g., including at least Al or machine learning model, neural network, etc.) may be used to analyze and compare the data with previous records (if any) of a current customer for a current rental, the current customer's data associated with other services/platforms (e.g., car rental, hotel rental, insurance, etc.), and other customer's usage data. Based one or more of these information, the Al software/application determines a rating of the customer. The rating maybe a rating of one rental or rental period. The rating may be stored in a centralized database (i.e., centralized in relation to a plurality of platforms, applications, data sources, rental services, etc.) containing, but not limited to, user information, previous ratings, and rental history for various service providers or companies. The Al software/application may then determine an overall score for the customer (hereafter “score factor”) using the information stored in the centralized database, and may then determine a service fee based on the score factor. In one or more example embodiments, one or more of the rating, the score factor, and the service fee will be presented to the customers, such that the customers will be encouraged to maintain or increase their rating by, e.g., driving the rental vehicle safely and appropriately. In addition, the accuracy of the service fee (which the customers will be charged) will be improved, since the service fee is computed with a score factor that is computed based on information (e.g., ratings of the same customers, usage history of the same customers, etc.) provided by multiple service providers in the centralized database.

Although the example embodiments discussed above reference a car rental as the provided service and a car rental as the service fee, it is understood that one or more example embodiments are not limited thereto. For example, according to other embodiments, the service can be a hotel service, an insurance service, or any other suitable services, and the service fee can be any expanses associated to the respective service.

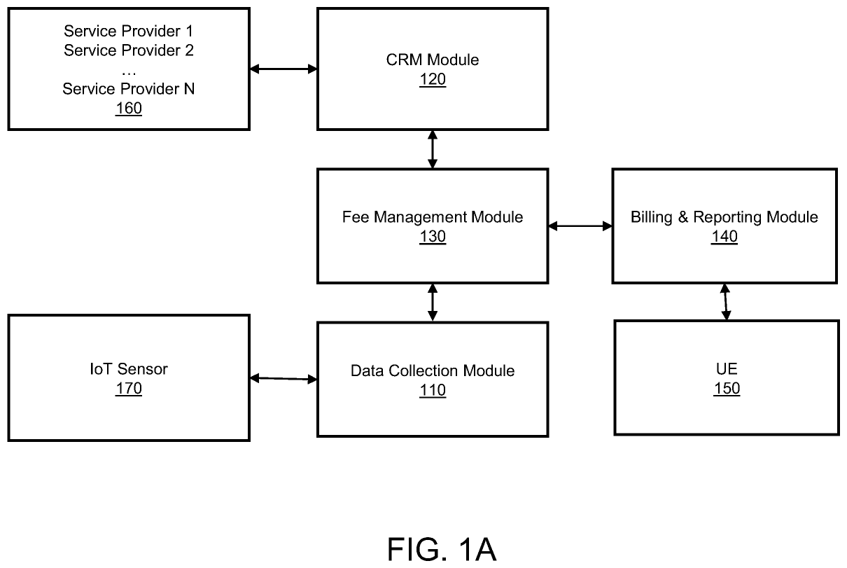

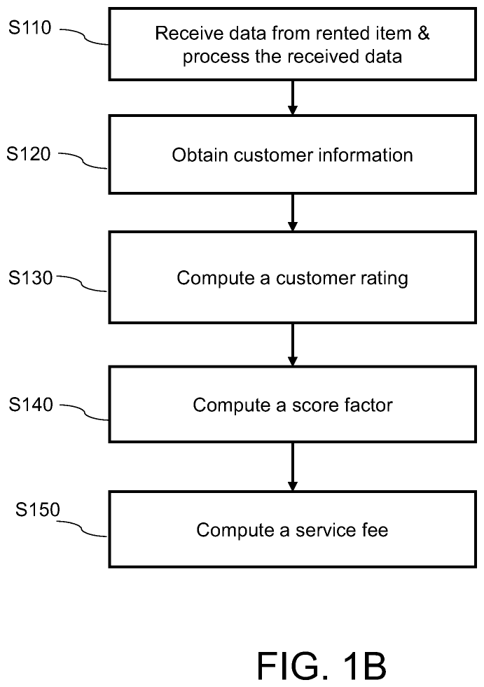

FIG. 1A illustrates a block diagram of a system for providing rating-based fee charging according to one or more embodiments. Embodiments described herein are not intended to limit the use or implementation of the disclosure.

As shown in FIG. 1A, according to an embodiment, a system for providing rating-based includes a data collection module 110, a customer relationship management (CRM) module 120, a fee management module 130, and a billing and reporting module 140.

The data collection module 110 may continuously (or periodically, discontinuously based on event trigger, etc.) collect and process (e.g., normalize, filter, enrich, etc.) data (e.g., raw data on the usage and user's behavior) from a device (e.g., a rented device such as a rented vehicle, etc.), and provide the processed data to the CRM module 120. Specifically, the device includes or is provided with (e.g., by a service provider) an IoT sensor 170. The IoT sensors 300 are configured to communicate with the data collection module 110 via wireless communication (e.g., via a radio access network (RAN)) such that usage data can continuously be provided to the data collection module 110 (e.g., via a data platform gateway connected to the RAN). According to another embodiment, the usage data may be provided periodically or in response to a triggering event. The IoT sensors 170 may include one or more Subscriber Identity Module (SIM)-based sensors, e.g., sensors communicatively coupled to one or more SIMs such as a standard SIM (2FF), Micro-SIM (3FF), Nano SIM (4FF), embedded SIM (eSIM), for example, MFF2, and any other suitable types of SIM. The RAN by way of which the usage data (e.g., raw usage data) may be received may include, for example, any one or more of a 2G, 3G, 4G, 5G, or any other suitable telecommunications technology. However, the system is not limited thereto, and may receive the raw data from the IoT sensors 170 by way of any wired or wireless communication.

In some embodiments, the data collection module 110 may receive data from the IoT sensor 170 by way of, for example, the RAN and an IoT gateway (which may be external to the system, included in the system, or included in the data collection module 130). The data collection module 110 may then perform processing functions on the raw data such as encoding, decoding, normalization, filtration, enrichment, etc., and may then transmit processed data to the CRM module 120 (to be described below).

The CRM module 120 is a centralized inventory and user's information management module accessible by a plurality of service providers 160 (e.g., providers of same type of services such as vehicle rental companies, providers of different types of services such as a vehicle rental company and an insurance company, etc.) via, by way of example, a portal gateway. In an embodiment, the CRM module 120 may also communicate with customers (user equipment (UE) 150 in FIG. 1A) via the portal gateway or a different portal.

The CRM module 120 may be configured to receive and maintain (e.g., in a database or storage) customer information (e.g., user rating, rental status, rental history, historical consumption information associated with the customer, etc.) from the plurality of service providers 160. At least some of the utilities providers 160 may, although not necessarily, be of the same company. The customers may, for example, be existing or prospective customers of one or more service providers 160. Further, the CRM module 120 may be configured to receive and maintain (e.g., in a database or storage) item information (e.g., information on the usage and user's behavior) provided by the fee management module 130 (to be described below).

The fee management module 130 may be configured to receive item information (e.g., in the form of processed data) from the data collection module 110, retrieve (from the CRM module 120) customer information associated to the item information, analyze the item information and the associated customer information (e.g., via an AI/ML application stored therein) to compute a rating for the customer, compute a score factor based on the rating, and compute a service fee based on the score-factor. In an embodiment, the fee management module 130 provides the item information, the computed customer rating, the computed score factor, and the computed service fee to the CRM module 120 for storing.

The billing and reporting module 140 is configured to receive information of the service fee from the fee management module 130. Further, the billing and reporting module 140 is configured to generate a billing invoice for the customer, wherein the billing invoice includes the billing amount of the service/rental, the score factor of the customer, and the rating of the customer. In an embodiment, the billing and reporting module 140 may provide the billing invoice, the score factor, and/or the rating via a graphical user interface (GUI) accessible by the customer.

In some embodiments, the fee management module 130 may receive the processed usage data in real time (e.g., via real time or event data streams, such as Kafka streams) and continuously compute and update the customer rating, customer score factor, and/or service fee in real time, such that a user accessing the system via UE 150 to view a usage report, a customer rating, or the like, can be provided with the latest information. Additionally, by utilizing a real time data stream in accordance with example embodiments, the customer rating, score factor, and/or fee may be calculated more efficiently and more accurately.

FIG. 1B a flowchart of an example process for computing a service fee according to one or more embodiments. The process may be performed by one or more elements illustrated in FIG. 1A.

At S110, the data collection module 110 receives data from a rented item (via IoT sensor 170) and processes the data.

At S120, the fee management module 130 receives the processed data from the data collection module 110, and then obtain customer information from CRM module 120 based on the processed data.

At S130, the fee management module 130 compute a customer rating for the customer's usage of the rental item based on the received processed data and the customer information. If the customer rating is already existing in the CRM module 120, the fee management module 130 will update the rating based (i.e., the customer rating will be based on a current rental period which may be different from a previously computed rating. In some embodiments, the fee management module 130 maps the received processed data and the customer rating to the customer information and provide the mapped data to the CRM module 120 for storing.

The billing and reporting module 140 may receive a request from a user (e.g., a customer, the associated service provider, etc.) via a UE 150 to compute a service fee. Upon receiving the request, at S140, the fee management module may retrieve the customer rating and the customer information from the CRM module 120, and compute a score factor based on the customer rating and the customer information.

At S150, the fee management module 130 may retrieve base-fee information (e.g., a fee pre-determined by the service provider) from the CRM module 120 (or any other suitable storage storing the base-fee information) and compute a service fee based on the score factor and the base-fee information. Accordingly, the fee management module 130 may provide the computed service fee to the billing and report module 140, and the billing and report module 140 may then present the service fee information to the user (e.g., via a GUI).

While FIG. 1B shows example operations of the process, in some implementations, the process may include additional operations, fewer operations, different operations, or differently arranged operations than those depicted in FIG. 1B. Additionally, or alternatively, two or more of the operations of the process may be performed in parallel or combined.

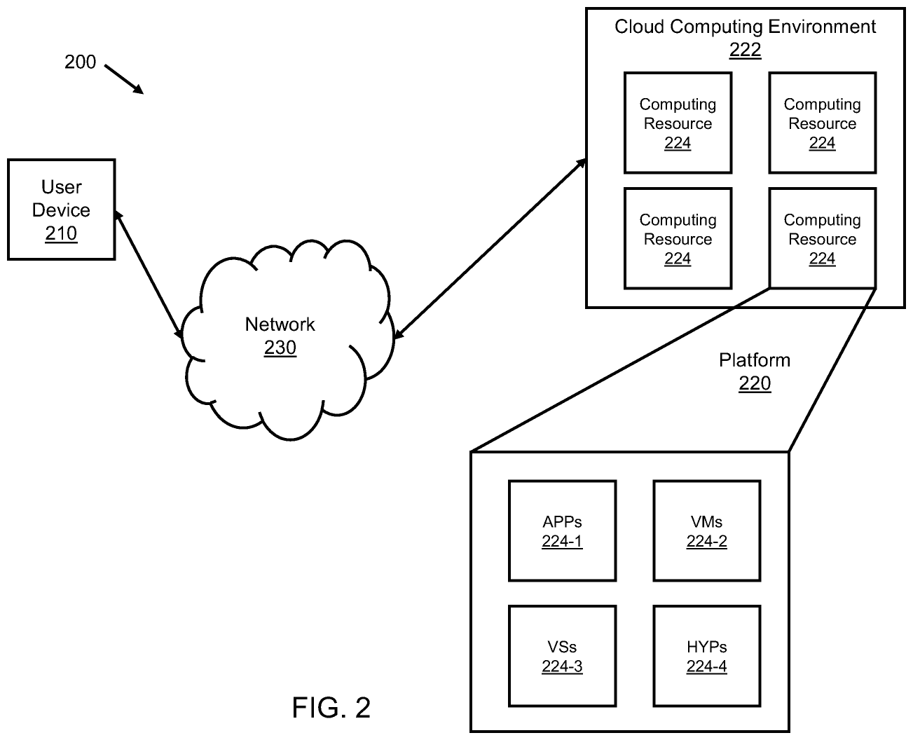

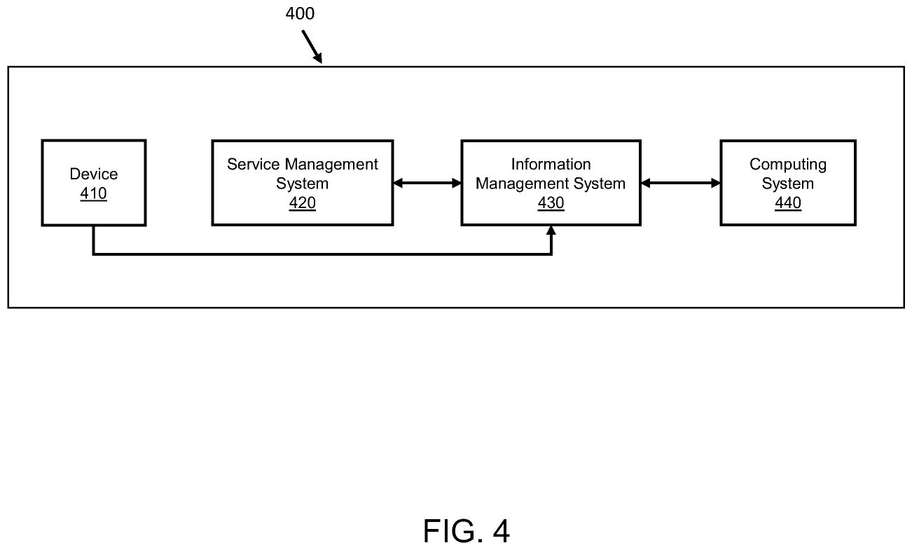

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In one or more embodiments, any of the functions and operations described with reference to FIG. 1B above (or FIGS. 4-10 below) may be performed by any combination of elements illustrated in FIG. 2.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 may not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

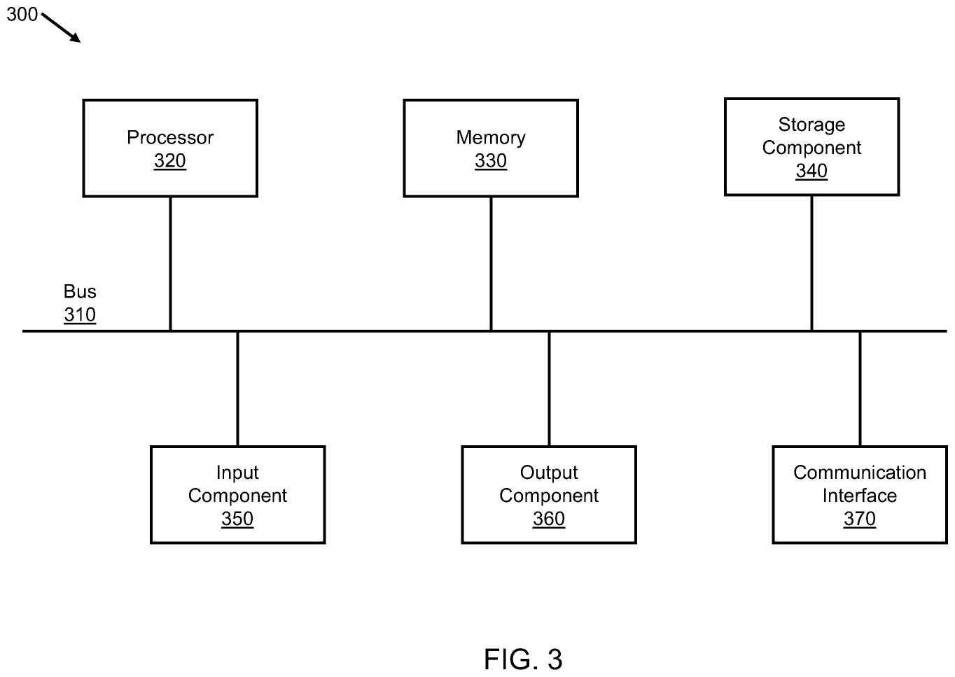

FIG. 3 is a diagram of example components of a device 300. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In embodiments, any one of the operations or processes of FIGS. 1 and 4-7 may be implemented by or using any one of the elements illustrated in FIGS. 2 and 3.

FIG. 4 illustrates a diagram of a centralized rental fee processing system 400 in accordance with one or more embodiments. The centralized rental fee processing system 400 includes a device 410, a user management system 420, a user information module 430, and a computing module 440. The device 410 may be one or more sensors (e.g., IoT sensors in a vehicle), or the like, connected to or implemented in a rental item. The device 410 is communicatively coupled to the user management system 420 and the user information module 430. The user management system 420 may include a plurality of user management systems, each of which is associated with a rental service. The rental services may be of the same service type (e.g., another car rental company) or a different service type (e.g., a hotel rental, insurance, etc.). Information from the plurality of user management systems (i.e., rental services) are centralized and stored in the user management system 420 and may be retrieved from the user management system 420. Methods described in accordance with embodiments may be performed by one or more processors included in the user information module 430 and the computing module 440 configured to perform operations and/or read program code from at least one memory and operate as instructed by the program code. As shown in FIG. 4, the user information module 430 is communicatively coupled to the computing module 440, the user management system 420, and the device 410.

According to embodiments, the user information module 430 receives usage data from the device 410 and the user information from user management system 420. The usage data may be continuously transmitted from the device 410 to the user information module 430 during a rental period of the rental item. In some embodiments, the usage data may be recorded and transmitted to the user information module 430 at the end of the rental period. User information transmitted from the user management system 420 to the user information module may include ratings, usage data, score factors, etc., associated with a customer. As such, the received user information may include data from multiple platforms or services. The user information module 430 maps the received usage data to the user information, and stores the mapped data in the user information module 430 (i.e., a repository included in the user information module 430 or externally connected to the user information module 430 or the centralized rental fee processing system 400). In some embodiments, the usage data is sent to the user management system 420, which then transmits the usage data to the user information module 430 for mapping.

In some embodiments, user information module 430 processes (e.g., normalizes, filters, etc.) the received usage data before mapping the usage data to the user information.

Upon completion of the rental period (e.g., the customer returns the rental car, the customer checks out of the hotel room, etc.), the computing module 440 receives a request for computing a rental fee for a customer from the user management system 420. Subsequently, the computing module 440 retracts the mapped data associated with the customer from the user information module 430. The computing module 440 then computes a score factor for associated with the customer based on the mapped data. The score factor is stored in the computing module 440 (i.e., a repository included in the computing module 420 or externally connected to the computing module 440).

In some embodiments, the computing module 440 first computes a current rating for the customer based only on the usage data of a current rental item (i.e., the most recent rental item) and stores the rating in the computing module 440. The current rating may also be stored in the user information module 430 for future use. That is, the current rating is based on the usage data of the current rental item and is updated in the user information module 430 and used to compute a score factor for the next usage of a rental service. The current rating may represent a score rating user performance, user consumption, etc. Advantageously, by utilizing only past ratings to compute a score factor and the final rental fee, the customer may be provided with a bill estimate at the time of renting or before renting the rental item. Therefore, customers are able to appropriately determine if they choose to continue with the rental process before incurring any fees. This method also prevents possible disputes based on charged fees after the rental period is complete.

In another embodiment, the current rating is used to calculate the score factor for the current rental item, as well as past ratings. The computing module 440 may use an Al software to process the usage data and automatically generate the rating based on the usage data from the current rental. In some embodiments, the computing module 440 waits a predetermined period of time after the completion of the rental period and processes the usage data to generate the current rating. Accordingly, the current rating (along with previous ratings and the user information) may then be used to compute the score factor. The user information may include data from a plurality of user management systems (i.e., companies/platforms). As such, the computing module 440 may weigh the data from the plurality of user management systems based on the service type and compute the score factor based on the weighted values. For example, provided services similar to the current rental item or service may be weighted higher than an unrelated service. Further, the user information may include ratings and score factors (or a rating or score average) associated with other customers included in the user management system 420. Therefore, the computing module 440 may use data associated with the customer as well as other customers, e.g., of the same service or a different service to compute the score factor.

If a new customer is a first time user of the current rental company (i.e., the are no previous records or user information associated with the customer within the same company to be mapped to the usage data) but has used another company corresponding to one of the plurality of user management systems included in the user management system 420, the user management system of the company corresponding to the current rental (hereafter “current rental company”) may retrieve user information and previous records from the other company corresponding to one of the plurality of user management systems. The current rental company (via the user management system 420 of the rental company) may make a request for computing the rental fee to the user information module 430. The request includes the information of the new customer (e.g., legal name, driving license number, passport number, etc.). In response to the request, the user information module 430 collects, based on the information include in the request, user information and data (e.g., usage data and ratings) associated with the customer and stored in the user management system 420 by other companies. The information and data may be provided by an associated company (e.g., any company having connection to the current rental company, such as a subsidiary company of the rental company, a company having a partnership with the rental company, etc.), and may include, but not limited to, ratings and customer status (VIP user, loyal user, non-active user, etc.). The user information module 430 may also collect usage data from the device 410. In some embodiments, the usage data is first provided by the device 410 to the user management system associated with the current rental company and then provided by the user management system to the user information module 430. Subsequently, the user information module 430 maps the usage data of the customer to the collected information and data associated with the customer from the different companies. The mapped data may be stored in the user management system 420 (i.e., the user management system associated with the current rental) and/or the user information module 430. As mentioned above, the computing module 440 then computes the score factor based on the mapped data.

If the new customer is new to the current rental company and has no user information stored in any one of the plurality of user management systems included in the user management system 420, then the score factor may be computed based only on the usage data of the current rental item. For example, the current rating of the current rental item may be the score factor.

After the score factor is computed, the computing module 440 retracts base-fee information. The base-fee may be pre-defined by the user management system 420 (i.e., each of the rental companies may pre-set or determine the base-fee for their rental service). The rental fee is computed based on the score factor and the base-fee information. A list of scores are stored in the computing module 440. The score list includes score factors (i.e., previously computed scores), each of which is associated with a category of the user information. Table 1 is an example of a score list stored in the computing module 440. The categories in the score list may be pre-defined by the rental company. As such, rental companies may create their own rules and score lists. The rules and score lists may be revised by the rental company at any time.

TABLE 1
Score List

| Category | Score |
|---|---|
| VIP user | 5 |
| Active user | 4 |
| New user | 3 |
| Non-active user | 0 |
| Blacklisted user | −10 |
| User rating >4.5 | 8 |
| User rating <3 | −5 |

As shown in Table 1, a category included in the score list may be VIP user, Active user, New user, Non-active user, Blacklisted user, etc. The score list may include other categories not listed in Table 1. Each category may be associated with a score that would impact the user's rental fee. For example, assuming that a customer is a VIP user and has a user rating greater than 4.5, the score factor may be computed as the summation of the score associated with a VIP user (i.e., 5) and the score associated with a user rating >4.5 (i.e., 5). Therefore, the score factor would be 13 (i.e., 5+8=13). Accordingly, this score factor can be applied in the rental fee computation with any appropriate mathematical processes. For example, the rental fee computation may be computed based on the following equation:

$$Rental Fee = \frac{Score factor}{100} * Current rating * {Base}_{fee} \qquad ( Equation 1 )$$

The rental fee, the score factor, the ratings, and the score list may be provided and/or stored in the user management system 420 (i.e., one or more of the rental companies included in the user management system 420) or a database communicably coupled to the user management system 420 and/or the centralized rental fee processing system 400.

One or more of the score factor, the current rating, previous ratings, and the rental fee may be displayed by the user management system 420 to, e.g., the rental company or a representative of the rental company. A difference between the lowest charged amount (i.e., rental fee charged) to other customer for a same or similar rental item may also be computed and displayed.

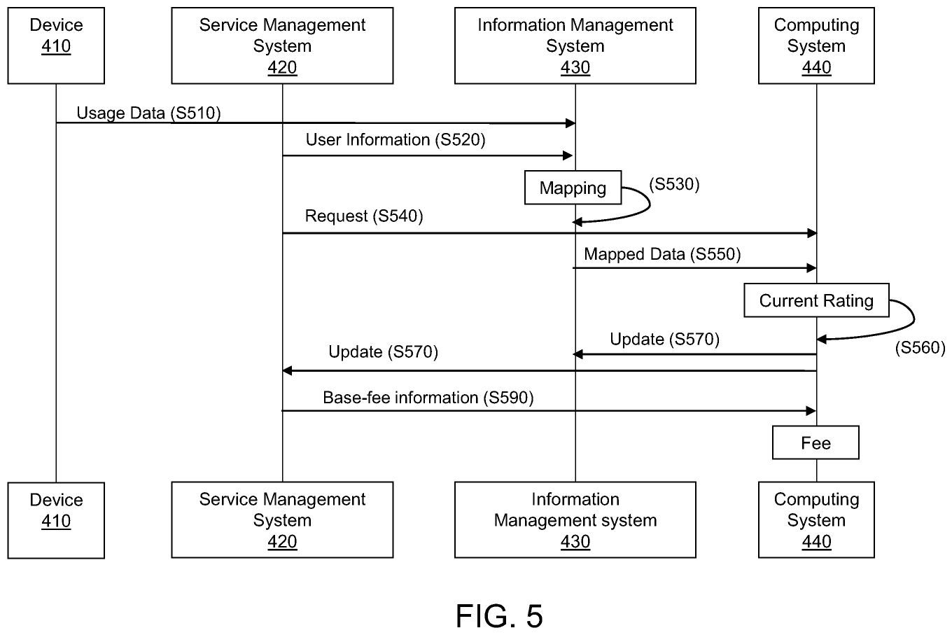

FIG. 5 is a sequence diagram illustrating an example of a data flow in accordance with embodiments with reference to FIG. 4. The data flow assumes that the customer is an existing customer of the current rental company (i.e., has previous records with the current rental company) and an existing member of one or more of the companies with user management systems included in the user management system 420.

First, the device 410 sends usage data to the user information module 430 of the centralized fee processing system 400 (S510). The user management system 420 sends user information to the user information module 430 (S520). The user information may including previous records (from the plurality of user management systems included in the user management system 420), previous ratings, etc. The usage data and user information may be sent simultaneously. In some embodiments, the usage data and user information is sent at the completion of the rental period or periodically during the rental period.

Next, the user information module 430 maps the usage data to the user information. The user information module 430 stores the mapping in the user information module 430 (S530). Additionally, the mapping may also be stored in the user management system 420.

When the rental period is complete, the user management system 420 sends a request to the computing module 440 to compute a fee (S540). The fee is a cost of the renal item for the rental period. In response to the request, the computing module 440 retracts the mapped information from the user information module 430 (S550). In some embodiments, the computing module 440 may send, e.g., an API request to the user information module 430 for the mapped information. Then, the computing module 440 receives an API response including the mapped information.

Next, the computing module 440 computes a current rating for the rental period based on the usage data. The current rating is stored in the computing module (S560). The user management system 420 and the user information module 430 are then updated with the current rating and store the rating for future use (S570).

The computing module 440 computes, based on the current rating and the mapped information, a score factor. The score factor is stored in the computing module 440 (S580).

Next, the computing module 440 retracts base-fee information from the user management system 420 (S590). In some embodiments, the computing module 440 may send, e.g., an API request to the user management system 420 for the base-fee information. Then, the computing module 440 receives an API response including the base-fee information. Lastly, based on the base-fee information and the score factor, the computing module 440 computes the fee.

Note that the steps in the sequence diagram described with reference to FIG. 5 are not intended to limit the configuration of data flow in embodiments. For example, one or more of the steps may be performed simultaneously, data may be stored and/or flow to in directions not explicitly illustrated in the data flow of FIG. 5, etc.

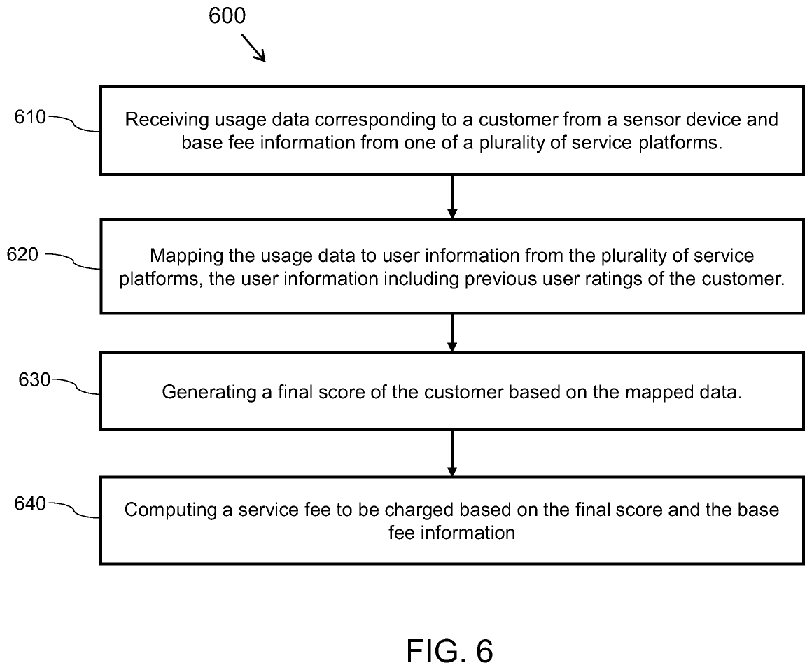

FIG. 6 is an exemplary flowchart illustrating a method 600, performed by at least one processor, for computing a service fee for a rental item, according to an embodiment.

In some implementations, one or more process blocks of FIG. 6 may be performed by the platform 220. In some implementations, one or more process blocks of FIG. 6 may be performed by another device or a group of devices separate from or including the platform 220, such as the user device 210.

As shown in FIG. 6, in operation 610, the method 600 may include receiving usage data corresponding to a customer from a sensor device and base fee information from one of a plurality of service platforms. The usage data may be received at an end of a rental period of the rental item.

In operation 620, the method 600 may include mapping the usage data to user information from the plurality of service platforms, the user information including previous user ratings of the customer.

In operation 630, the method 600 may include generating a final score of the customer based on the mapped usage data. In some embodiments, the a current rating based on the usage data may be generated. The plurality of service platforms may be updated with the current rating a previous user rating of the customer. Therefore, the final score of the customer may be generated based on the current rating and the mapped usage data. In some embodiments, the current rating is the final score (e.g., when there is no user information associated with the customer in the plurality of service platforms). In some embodiments, the final score is generated based on the mapped usage data and user information associated with other customers of one or more of the plurality of service platforms.

In operation 640, the method 600 may include computing a service fee to be charged based on the final score and the base fee information.

Subsequently, the method 600 may include charging the customer based on the generated service fee.

Although FIG. 6 shows example operations of the method, in some implementations, the method may include additional operations, fewer operations, different operations, or differently arranged operations than those depicted in FIG. 6. Additionally, or alternatively, two or more of the operations of the method may be performed in parallel or combined.

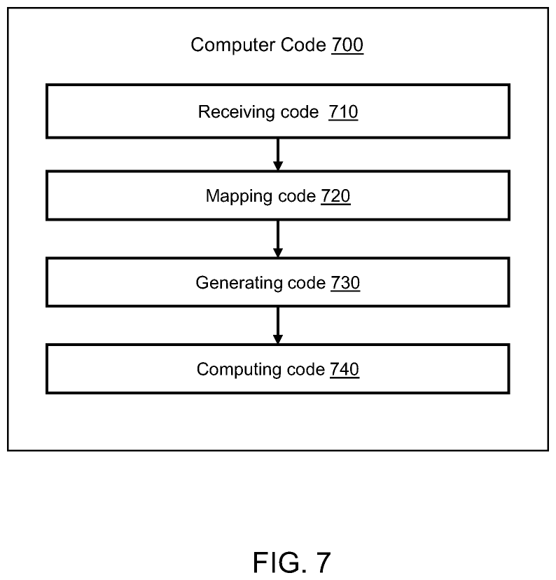

FIG. 7 is a block diagram of an example of computer code for computing a service fee, according an embodiment. According to embodiments of the present disclosure, an apparatus/device including at least one processor with memory storing computer code may be provided. The computer code may be configured to, when executed by the at least one processor, perform any number of aspects of the present disclosure.

As shown in FIG. 7, the computer code 700 includes receiving code 710, mapping code 720, generating code 730, and computing code 740.

The receiving code 710 is configured to cause the at least one processor to receive usage data corresponding to a customer from a sensor device and base fee information from one of a plurality of service platforms. The usage data may be received at an end of a rental period of the rental item.

The mapping code 720 is configured to cause the at least one processor to map the usage data to user information from the plurality of service platforms, the user information including previous user ratings of the customer.

The generating code 730 is configured to cause the at least one processor to generate a final score of the customer based on the mapped usage data. The computer code 700 may further be configured to cause the at least one processor to generate a current rating based on the usage data and update the plurality of service platforms with the current rating a previous user rating of the customer. Therefore, the final score of the customer may be generated based on the current rating and the mapped usage data. In some embodiments, the current rating is the final score (e.g., when there is no user information associated with the customer in the plurality of service platforms). The computer code 700 may further be configured to cause the at least one processor to generate the final score based on the mapped usage data and user information associated with other customers of one or more of the plurality of service platforms.

Lastly, the computing code 740 is configured to cause the at least one processor to compute a service fee to be charged based on the final score and the base fee information.

Although FIG. 7 shows example blocks of the computer code 700 of a system or apparatus according to embodiments, in some implementations, the system may include additional blocks, fewer blocks, different blocks, or differently arranged blocks than those depicted in FIG. 7. Additionally, or alternatively, two or more of the blocks of the system may be combined. In other words, while FIG. 7 shows distinct blocks of code, the various code instructions need not be distinct and could be intermingled.

Embodiments of the present disclosure relate to computing a service/rental fee based on rating of a customer. The rating my incorporate the customer's performance or usage of the rental item. A final scoring used to compute the service fee may be based on one or more of the rating as well as a market expectations set by other customers and their performance/usage, the customer's status, and the customer's previous ratings. As such, the customer is charged with a fee that is more accurate and more clearly reflects the customers behavior (in addition to the actual consumption of the service). This will encourages customer loyalty, good behavior/performance, reduce churn rate of customers, and reduce potential additional maintenance costs for the rental company. Methods described herein provide an eco-system for multiple rental companies (e.g., car rental, hotel rental, etc.) to share user information and to dynamically compute a rental fee most appropriate for the user.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for computing a service fee of a rental item, performed by at least one processor and comprising:
receiving usage data corresponding to a customer from a sensor device and base fee information from one of a plurality of service platforms;
mapping the usage data to user information from the plurality of service platforms, the user information including previous user ratings of the customer;
generating a final score of the customer based on the mapped usage data; and
computing a service fee to be charged based on the final score and the base fee information.

2. The method of claim 1, further comprising generating a current rating based on the usage data and updating the plurality of service platforms with the current rating, wherein the current rating is stored as a previous user rating of the customer.

3. The method of claim 2, further comprising generating the final score of the customer based on the current rating and the mapped usage data.

4. The method of claim 1, further comprising charging the customer based on the generated service fee.

5. The method of claim 1, wherein the usage data is received at an end of a rental period of the rental item.

6. The method of claim 1, further comprising generating the final score based on the mapped usage data and user information associated with other customers of one or more of the plurality of service platforms.

7. The method of claim 2, wherein the current rating is the final score.

8. An apparatus for computing a service fee for a rental item, the apparatus comprising:
at least one memory configured to store program code; and
at least one processor configured to read the program code and operate as instructed by the program code, the program code configured to case the at least one processor to:
receive usage data corresponding to a customer from a sensor device and base fee information from one of a plurality of service platforms;
map the usage data to user information from the plurality of service platforms, the user information including previous user ratings of the customer;
generate a final score of the customer based on the mapped usage data; and
compute a service fee to be charged based on the final score and the base fee information.

9. The apparatus of claim 8, wherein the at least one processor is configured to read the program code and operate as instructed by the program code to generate a current rating based on the usage data and updating the plurality of service platforms with the current rating, wherein the current rating is stored as a previous user rating of the customer.

10. The apparatus of claim 9, wherein the at least one processor is configured to read the program code and operate as instructed by the program code to generate the final score of the customer based on the current rating and the mapped usage data.

11. The apparatus of claim 8, wherein the at least one processor is configured to read the program code and operate as instructed by the program code to charge the customer based on the generated service fee.

12. The apparatus of claim 8, wherein the usage data is received at an end of a rental period of the rental item.

13. The apparatus of claim 8, wherein the at least one processor is configured to read the program code and operate as instructed by the program code to generate the final score based on the mapped usage data and user information associated with other customers of one or more of the plurality of service platforms.

14. The apparatus of claim 9, wherein the current rating is the final score.

15. A non-transitory computer readable medium storing instructions that, when executed by at least one processor of an apparatus for computing a service fee for a rental item, cause the at least one processor to:
receive usage data corresponding to a customer from a sensor device and base fee information from one of a plurality of service platforms;
map the usage data to user information from the plurality of service platforms, the user information including previous user ratings of the customer;
generate a final score of the customer based on the mapped usage data; and
compute a service fee to be charged based on the final score and the base fee information.

16. The non-transitory computer readable medium of claim 15, wherein the instructions further cause the at least one processor to generate a current rating based on the usage data and updating the plurality of service platforms with the current rating, wherein the current rating is stored as a previous user rating of the customer.

17. The non-transitory computer readable medium of claim 16, wherein the instructions further cause the at least one processor to generate the final score of the customer based on the current rating and the mapped usage data.

18. The non-transitory computer readable medium of claim 15, wherein the instructions further cause the at least one processor to charge the customer based on the generated service fee.

19. The non-transitory computer readable medium of claim 15, wherein the usage data is received at an end of a rental period of the rental item.

20. The non-transitory computer readable medium of claim 15, wherein the instructions further cause the at least one processor to generate the final score based on the mapped usage data and user information associated with other customers of one or more of the plurality of service platforms.
